(19) United States
(12) Patent Application Publication
(10) Pub. No.: US 2009/0080897 A1
(43) Pub. Date: Mar. 26, 2009

(54) BI-DIRECTIONAL OPTICAL MODULE COMMUNICATING WITH SINGLE FIBER

(75) Inventors: Manabu SHIOZAKI, Yokohama-shi (JP); Katsuhisa TAWA, Yokohama-shi (JP); Toshiaki KIHARA, Yokohama-shi (JP); Hiromi KURASHIMA, Yokohama-shi (JP)

Correspondence Address: VENABLE LLP, P.O. BOX 34385, WASHINGTON, DC, 20043-9998, US

(73) Assignee: SUMITOMO ELECTRIC INDUSTRIES, LTD., Osaka-shi (JP)

(21) Appl. No.: 12/233,329

(22) Filed: Sep. 18, 2008

(30) Foreign Application Priority Data
Sep. 21, 2007 (JP) 2007-245997

(51) Int. Cl. H04B 10/13

(52) U.S. Cl. 398/139

(57) ABSTRACT

A bi-directional optical module with an improved arrangement of the PD and the LD is disclosed. The LD is mounted on the stem through the LD carrier and the metal block, while the PD is mounted on the stem through the PD carrier. The bottom level of the PD is lower than the top level of the metal block and the top level of the PD is lower than the top level of the LD carrier.

### BACKGROUND OF THE INVENTION

1. Field of the Invention

The present invention relates to a bi-directional optical module that installs both light-emitting device and light-receiving device within a same package.

2. Related Prior Art

The bi-directional module optically communicates with a single fiber, that is, both light-receiving device and light-emitting device are installed within the same package, has been well known in the field. Because the current to drive the light-emitting device, typically a semiconductor laser diode (LD), is far grater than a photocurrent generated in the light-receiving device, typically a photodiode (PD), the receiving electrical signal is influenced by the driving signal, which is often called as the crosstalk.

The U.S. Pat. No. 7,093,988, has disclosed a bi-directional module with a double cap configuration, one of cap, an external cap, encloses the LD, the PD and the wavelength division multiplexing (WDM) filter therein, while, the other of which, an inner cap, electrically isolates the PD from the LD. The Japanese Patent Application published as JP 2003-282896A has another bi-directional module in which the WDM filter between the LD and the PD has a metalized surface electrically connected to the ground to isolate the PD from the LD to reduce the crosstalk noise appeared in the PD.

However, the double cap configuration shown in the prior art above is necessary to enlarge the size of the housing. Recent optical communication inevitably requests small sized and lower powered devices. The double cap configuration above does not meet such request probably. While, the structure of the WDM filter appeared in the second reference above may degrade the optical performance of the filter.

### SUMMARY OF THE INVENTION

A bi-directional optical module according to the present invention, which communicates with the single fiber and provides a stem as a part of a housing thereof, comprises an LD mounted on the stem through an LD carrier, a PD also mounted on the stem through a PD carrier, a wavelength selective filter also mounted on the stem, and a block to mount the LD through the LD carrier. A feature of the present bi-directional module is that the block is made of conductive material, and a bottom level of the PD is lower than a top level of the block and the top level of the PD is lower than a top level of the LD carrier.

The arrangement of the LD, the PD and the block above may effectively shield the electromagnetic field originated around the LD and propagated to the PD because the block, in particular, the side wall thereof may form the equi-potential ground plane along the wall between the LD and the PD, which may effectively shield the electromagnetic field.

The module of the present invention may further provide two posts to support the filter. The posts may be made of electrically conductive material and positioned so as to put the PD therebetween. The posts thus arranged may shield the electromagnetic field originated around the LD and run around the sides of the PD.

### BRIEF DESCRIPTION OF DRAWINGS

FIG. 1 is a perspective view showing a primary part on the stem of the bi-directional module according to the first embodiment of the invention;

FIG. 2 is a cross section of the module taken along the line II-II appeared in FIG. 1;

FIG. 3 is a circuit diagram of the optical module of the invention;

FIG. 4 shows the crosstalk of the module without the conductive block below the LD and with block with various thicknesses thereof;

FIG. 5 shows the reduction of the crosstalk of the module with the block;

FIG. 6 is a perspective view of the bi-directional optical module with a first modified structure;

FIG. 7 is a perspective view of the module with a second modified structure;

FIG. 8 is a perspective view of the module with a third modified structure;

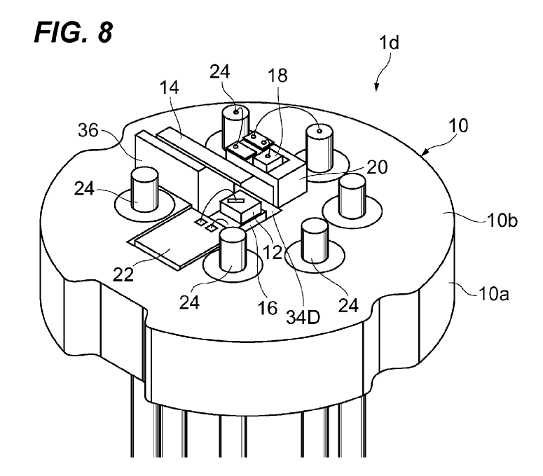

FIG. 9 is a perspective view of the module with a fourth modified structure;

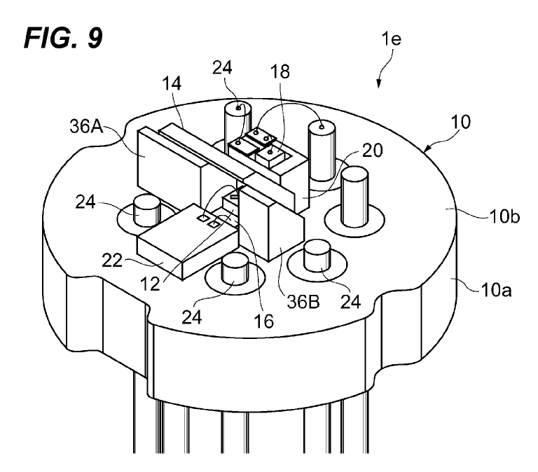

FIG. 10 shows the reduction of the crosstalk obtained in the fourth modified structure shown in FIG. 9;

FIG. 11 is a perspective view of the module with a fifth modified structure; and

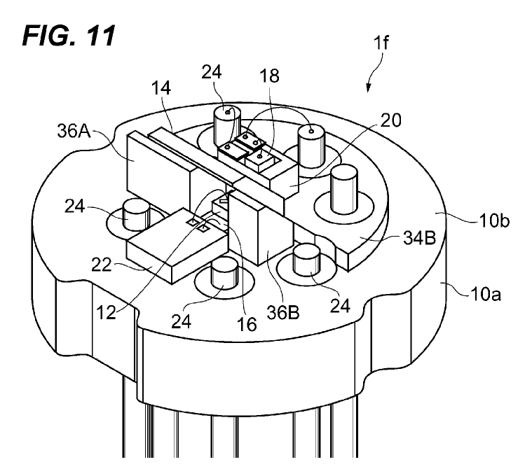

FIG. 12 shows the reduction of the crosstalk obtained in the fifth modified structure shown in FIG. 11.

### DESCRIPTION OF PREFERRED EMBODIMENTS

Next, preferred embodiments according to the present invention will be described as referring to accompanying drawings. In the description of the drawings, the same numerals or the same symbols will refer to the same elements without overlapping explanations.

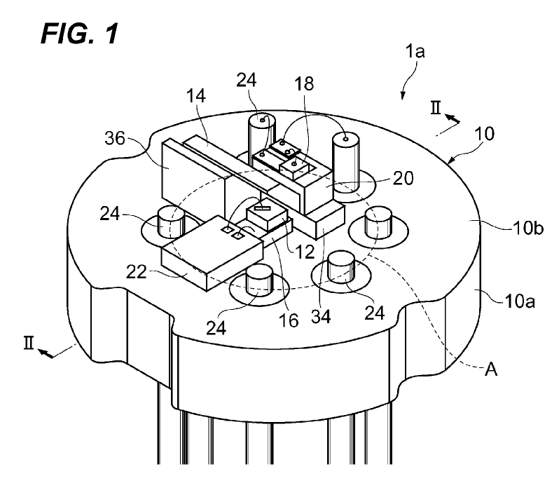

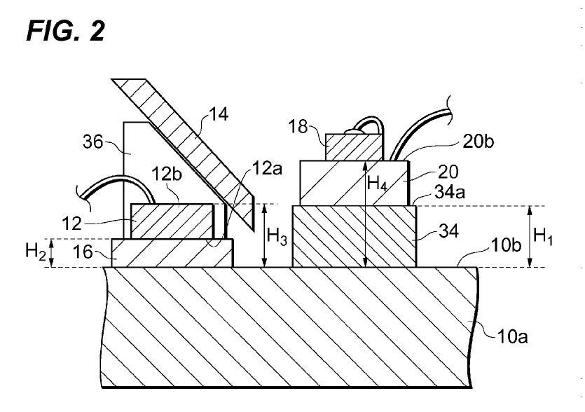

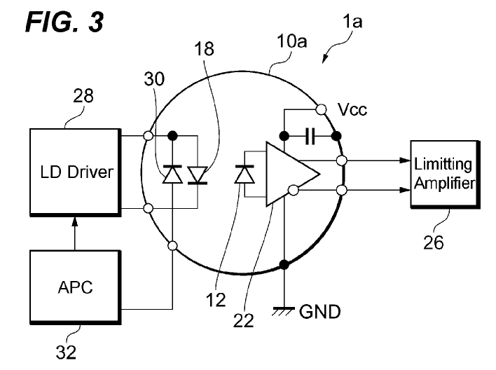

FIG. 1 is a perspective view of an optical module 1a according to an embodiment of the invention, FIG. 2 is a cross section taken along the line II-II appeared in FIG. 1, and FIG. 3 is a circuit diagram of the module 1a. The optical module shown in FIGS. 1 to 3 is applicable as an optical transceiver to the bi-directional optical communication whose transmission speed exceeds, for instance, 1 GHz.

The optical module la has a package 10 including a electrical conductive stem 10a with a disk shape whose diameter of around 5.6 mm, and a lens cap, which is not shown in FIGS. 1 to 3, to support a lens or a transparent window and to seal a cavity air-tightly into which electrical and optical devices are installed therein on the primary surface 10b of the stem. The area A with a radius of 1.4 mm measured from the center of the primary surface 10b mounts a photodiode (PD) 12, a wavelength selectable filter 14, a PD carrier 16, a laser diode (LD) 18, an LD carrier 20, a pre-amplifier 22, and a monitor PD 30. FIGS. 1 to 2 omit the monitor PD 30.

The stem 10a fixes a plurality of lead pins 24 by a seal glass with a low melting point. These lead pins 24 are arranged so as to surround the area A, and perform functions of power supply pins, the ground pin, and signal I/O pins. Bonding wires with a diameter of about 30 μm connect respective lead pins with corresponding devices.

The PD 12 converts an optical signal provided from the optical fiber, which is not shown in the figures, into a corresponding electrical signal, namely, the photocurrent. The PD 12 is connected with a pre-amplifier 22 with bonding wires and this pre-amplifier 22 converts the photocurrent into a voltage signal by a preset conversion gain and outputs this voltage signal to the limiting amplifier (LA) 26 through the lead pin 24.

The PD 12 is mounted on the primary surface 10b through the PD carrier 16 whose shape is substantially rectangle. Interconnecting patterns formed on the PD carrier 16 and the bonding wires connect anode and cathode terminals of the PD 12 with the pre-amplifier 22. The PD carrier 16 electrically isolates the PD 12 from the conductive stem 10a and may be made of insulating material such as aluminum nitride (AlN) or aluminum oxide (Al₂O₃).

The LD 18, driven by a differential signal externally applied thereto, emits transmission light following the external signal. The transmission signal from the LD 18 heads for the optical fiber which is the same fiber that provides the optical signal to the PD 12 and coupled with the package 10. The LD 18 is connected with the LD driver 28 and is provided with the external signal from the LD driver 28. The monitor PD 30 arranged behind the LD 18, connected with the automatic power controller (APC) 32, which is externally provided, by the lead pin 24. This APC 32 adjusts the magnitude of the external signal provided from the LD driver 28 based on the signal provided from the monitor PD 30.

Referring to FIG. 1 again, the LD 18 is mounted on the primary surface 10b via a conductive block 34 and the LD carrier 20 with a substantially rectangular shape mounted on the conductive block 34. The conductive patterns formed on the LD carrier 20, the bonding wires and the lead pins 24 connect the anode and the cathode of the LD 18 with the LD driver 28.

Referring to FIG. 2, a level H₁ of the block 34 measured from the primary surface 10b is higher than a level H₂ of the bottom surface 12a of the PD 12 also measured from the primary surface 10b. In other words, the conductive block 34 in a thickness H₁ thereof is thicker than a thickness H₂ of the PD carrier 16. At the same time, a level H₄ of the top surface of the LD carrier 20 measured from the primary surface 10b is higher than a level H₃ of the top surface 12b of the PD 12. Furthermore, the conductive block 34 may have the thickness H₁ such that the level of the top surface 34a thereof is higher than the level H₃ of the top surface 12b of the PD 12, namely a summed thickness of the PD carrier 16 and the PD 12. This condition explained above forces the top surface 12b of the PD 12 lower than the top surface 34a of the conductive block 34.

Referring to FIG. 1 again, between the PD 12 and the LD 18 is arranged with the wavelength selectable filter 14 that distinguishes the transmission light from the receiving light. This filter 14, which is a type of optical components to transmit or to reflect light with predetermined wavelengths, selectively transmits the light provided from the optical fiber to the PD 12, while, selectively reflects the light provided from the LD 18 to the optical fiber. The filter 14 mounted on the metal post 36 arranged beside the PD 12 on the primary surface 10b.

In the optical module 1a described above, the LD 18 is driven by the differential signal whose magnitude reaches or exceeds about 10 mA, while, the photocurrent generated by the PD 12 is only a several micro-ampere, which is indeed a thousandth or ten thousandth of the driving current. Therefore, the driving current causes the electro-magnetic field in the area A that may influence the photocurrent or the voltage signal converted from the photocurrent and having a faint magnitude.

For instance, the wavelength of the electromagnetic wave with a frequency of 5 GHz, which corresponds to the data transmission speed of 10 Gbps, becomes only about 60 mm. Accordingly, the area A in a whole portion thereof with a diameter of about 3 mm may be exposed to the electromagnetic field due to the driving current when no protection for the electromagnetic induced noise is preformed. The receiving voltage signal with a faint magnitude is concealed by the electromagnetic noise due to the driving current, which is often called as the crosstalk.

In order to solve the subject mentioned above, it would be quite dominate how can shield the electromagnetic field caused by the driving current and how can suppress the noise effectively without compensating other factors, such as the size and the cost of the module. The module 1a of the present embodiment provides the conductive block 34 between the practical positions of the PD 12 and the LD 18 so as to conceal the top surface of the PD 12 from the LD 18. This block 34, by being connected with the stem 10a, forms a ground along the surface facing the side of the PD 12. The LD 18 is mounted on the block 34 via the LD carrier 20, which is insulating, such that the level becomes higher than the level of the top surface 12b of the PD 12. This arrangement may shield the electromagnetic field which is caused by the driving signal transmitted on the wiring pattern on the LD carrier 20 and directly heads for the PD 12.

When the level of the upper surface 12b of the PD 12 is lower than the height H₁ of the block 34, in which the block 34 is placed so as to hide the side of the PD 12 from the bottom 12a to the top 12b thereof, the block may effectively prevent the electromagnetic field generated around the LD 18 from affecting the PD 12. Moreover, optical components such as the wavelength selectable filter 14 are unnecessary to provide the function to shield the electromagnetic field; accordingly, such components in the material thereof may be selected by considering only the optical characteristic.

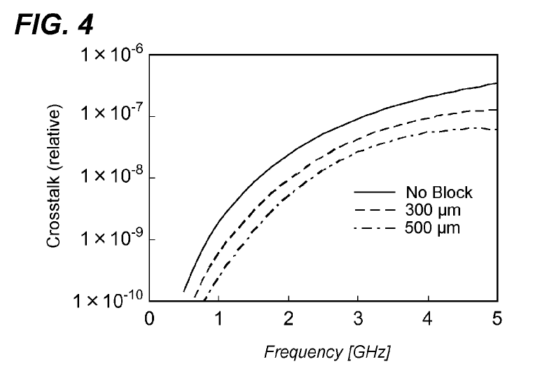

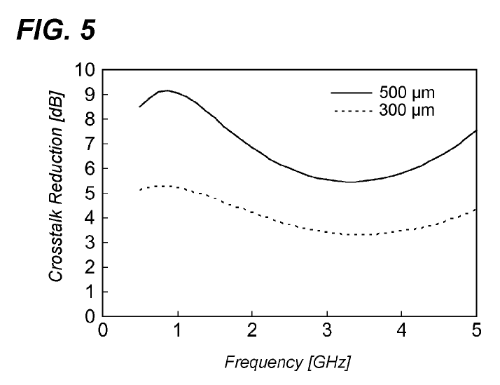

FIG. 4 shows the frequency dependence of the crosstalk appeared in the receiving electrical signal when the thickness H₁ of the block 34 is varied, and FIG. 5 indicates the degree of the reduction of the crosstalk, which is the ratio of the crosstalk without block 34 to that when the block 34 with thicknesses shown in the figure is provided. In FIGS. 4 and 5, the thicknesses of the PD carrier 16 and the PD 12 are assumed to be 200 μm, and the summed thickness of the block 34 and the LD carrier 20 is assumed to be 750 μm. As shown in the figures, the block 34 with greater thickness may effectively reduce the crosstalk in the wide frequency range.

The present invention is not restricted to the embodiment thus described. For instance, modified arrangements illustrated in FIGS. from 6 to 9 and 11 may be applicable.

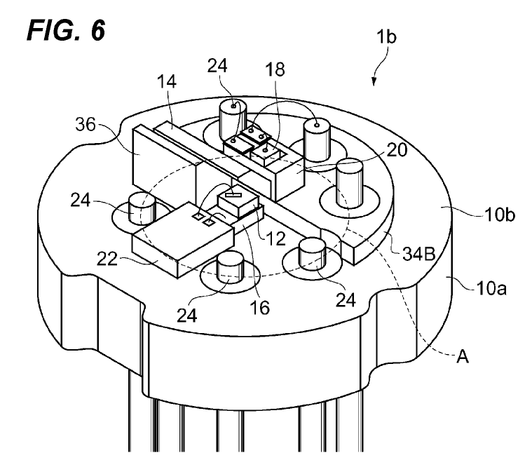

FIG. 6 is a perspective view of the first modified optical module 1b, in which the stem 10a forms a terrace 34B in place of the block 34 which covers an area, among the area A shown in FIG. 1, where the LD 18 and the LD carrier 20 are mounted. The terrace 34B may be a semi-circular shape and be formed by the stamping of the stem 10a.

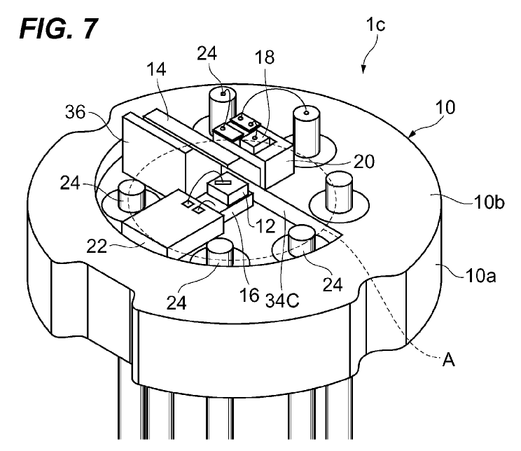

FIG. 7 shows the second modified module 1c, in which the stem 10a forms a hollow 34C with a semi-circular shape in an area where the PD 12, the filter 14 and the pre-amplifier 22 are mounted. The hollow 34D may have another shape, for instance, a polygonal formed so as to set at least the PD 12 therein. Such a terrace 34B or the hollows, 34C or 34D, may form the wall between the LD 18 and the PD 12, and the equi-potential grounded surface may be formed along the wall which may effectively shield the PD 12 from the LD 18. The modules, 1b to 1d, have an arrangement that the range to shield the PD 12 is expanded in a direction intersecting the axis connecting the PD 12 and LD 18; accordingly, the reduction of the crosstalk may be further enhanced. In addition, the hollow 34D of the module 1d may also effectively shield the electromagnetic field run around both sides of the PD 12.

The module of the invention may provide the LD carrier 20 made of ceramics such as aluminum nitride (AlN) with the plated surfaces, in place of the block 34. This type of the LD carrier 20 may perform the same function of the block 34 by being directly mounted on the primary surface 10b so the plated surfaces of the LD carrier 20 may form the equi-potential ground plane, which may effectively shield the electromagnetic field. The metal block 34 may be integrally formed with stem 10a by stamping or machining the stem 10a. The integrally arrangement of the block 34 may make it easy to form the small-sized module to toe reduce the production cost thereof.

As described above, the function to shield the electromagnetic wave becomes effective when the height H₁ of the block 34 becomes greater, which means the thickness of the LD carrier 20 is necessary to be thin as possible. However, the LD carrier 20 is generally made of ceramics, such as aluminum nitride (AlN), and such a thin ceramics slab is hard to handle because of the brittleness thereof. Therefore, it is preferable to prepare a component assembling a metal block with a thin ceramics slab attached to the metal block in advance and to cut this component to get the LD carrier 20 on the block 34 as shown in the figures.

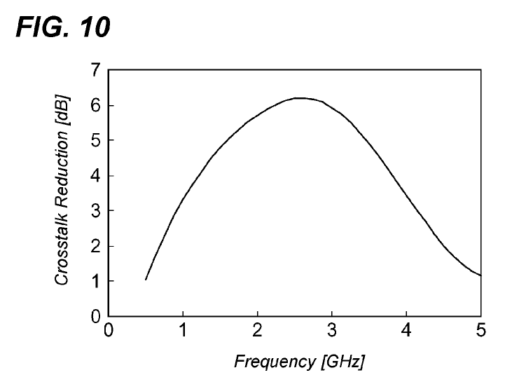

Another optical module 1e may be considered in which the stem 10a mounts two posts, 36A and 36B, made of metal so as to put the PD 12 therebetween. These posts, 36A and 36B, not only support the filter 14 but may shield the electromagnetic field generated around the LD 18 and run around the sides of the PD 12. The posts, 36A and 36B, may be formed by the stamping of the stem 10. FIG. 10 shows the reduction of the crosstalk, which is the ratio of the crosstalk when the module has the posts, 36A and 36B, to a case when the module provides the single post 34A. FIG. 10 clearly shows that the crosstalk may be reduced in a wide frequency range.

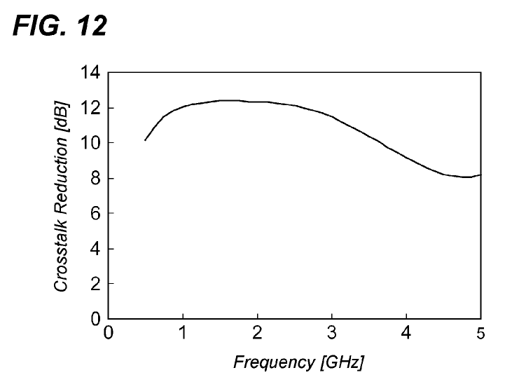

The optical module 1f may provide, in addition to the posts, 36A and 36B, the terrace 34B of the first modified embodiment shown in FIG. 6. The posts, 36A and 36B, and the terrace 34B may effectively shield the electromagnetic field directly propagated from the LD 18 to the PD 12 by the terrace 34B and that run around the sides of the PD 12 by the posts, 36A and 36B. FIG. 12 illustrates the reduction of the crosstalk for the module 1f. Two structures, the terrace 34B and the posts, 36A and 36B, may be further effective to reduce the crosstalk in the wider frequency range.

The block 34 and the posts, 36A and 36B, are not restricted to the metal member. Ceramics or plastics with a metalized surface may be applicable.

What is claimed is:

1. A bi-directional optical module communicating with a single fiber, said optical module having a stem to mount components thereon, comprising:
a semiconductor laser diode mounted on said stem through a laser diode carrier;
a photodiode mounted on said stem through a photodiode carrier;
a wavelength selective filter mounted on said stem; and
a block made of electrically conductive material, said block being configured to mount said laser diode carrier thereon and to be mounted on said stem,
wherein said photodiode provides a top level and a bottom level, said bottom level of said photodiode being lower than a top level of said block, and
wherein said top level of said photodiode is lower than a top level of said laser diode carrier.

2. The bi-directional optical module according to claim 1,
wherein said top level of said photodiode is lower than said top level of said block.

3. The bi-directional optical module according to claim 1,
further comprising two posts made of electrically conductive material to support said wavelength selective filter,
wherein said two posts are positioned so as to put said photodiode therebetween.

4. The bi-directional optical module according to claim 1,
wherein said block is integrally formed with said stem.

5. A bi-directional optical module communicating with a single fiber, said optical module having a stem to mount components thereon, comprising:
a semiconductor laser diode mounted on said stem through a laser diode carrier;
a photodiode mounted on said stem through a photodiode carrier; and
a wavelength selective filter mounted on said stem,
wherein said stem includes a hollow within which said photodiode are mounted,
wherein said photodiode provides a top level and a bottom level, said bottom level of said photodiode being lower than a bottom level of said laser diode carrier, and
wherein said top level of said photodiode is lower than a top level of said laser diode carrier.

6. The bi-directional optical module according to claim 5,
wherein said top level of said photodiode is lower than said bottom level of said laser diode carrier.

7. The bi-directional optical module according to claim 5,
further comprising two posts made of electrically conductive material to support said wavelength selective filter,
wherein said two posts are positioned so as to put said photodiode therebetween.
